(19) United States
(12) Patent Application Publication
(10) Pub. No.: US 2021/0298314 A1
(43) Pub. Date: Sep. 30, 2021

(54) SHEETER WITH REINFORCED STRIPPER WIRE MOUNT

(71) Applicant: J.C. Ford Company, La Habra, CA (US)

(72) Inventor: Scott D. Ruhe, La Habra, CA (US)

(21) Appl. No.: 17/217,075

(22) Filed: Mar. 30, 2021

Related U.S. Application Data
(60) Provisional application No. 63/002,235, filed on Mar. 30, 2020.

(51) Int. Cl. A21C 3/02; A21C 3/04; A21C 11/10

(52) U.S. Cl. CPC A21C 3/024; A21C 11/10; A21C 3/04

(57) ABSTRACT

A stripper wire mount arrangement for a dough sheeter can include first and second mounts disposed at the ends of a dough roller and a third mount disposed between the first and second mounts. The third mount can include multiple mounting locations for adjustment of the third mounting location.

### BACKGROUND OF THE INVENTIONS

### Field of the Inventions

The present inventions relate to improvements in high speed production sheeting devices for comestible products (e.g., tortillas and tortilla chips). More specifically, the present inventions relate to sheeting devices with improved stripper wire assemblies.

### Description of the Related Art

Corn tortillas and tortilla chips are cut from a sheet of corn dough, called “masa,” and then baked and/or fried. In mass production, the sheeting and cutting stages are accomplished by a tortilla sheeter.

High production tortilla sheeters feed masa from a hopper between a pair of large, stainless steel rollers which roll the masa into a sheet of substantially uniform thickness. The rollers are spaced apart in production to form a gap, known as a “pinch point gap,” through which the masa passes. The masa adheres to the surface of one of the rollers, known as the exit roller, after passing through the pinch point gap. A third roller then cuts the masa into either tortillas or tortilla chips. The third roller, known as a “cutting roller,” commonly has either circular shaped (for tortillas) or triangular-shaped (for tortilla chips) cutting guides positioned on the cylindrical external surface of the cutting roller. The cut tortillas or chips then are stripped from the exit roller by a stripper wire and/or a blower, or by a similar device.

### SUMMARY OF THE INVENTIONS

An aspect of at least one of the inventions disclosed herein includes the realization that the stripper wire of a dough sheeter is a limiting factor in the design of higher capacity and higher efficiency dough sheeter systems. For example, the stripping wire of a sheeter must be pulled against an outer surface of the front roller of a dough sheeter so as to cause cut pieces of dough to peel off of the front roller and fall onto an output conveyor. The stripping wire is subjected to wear by way of contact with the front roller, as well as contact with guide bands on the front roller. During operation, by way of frictional contact with the bands and front roller, the stripper wire is pulled upwardly and, due to contact with the bands and roller, the center of the stripping wire is pulled to a position higher relative to the ends of the stripper wire. Thus, the point of contact and thus the point of peeling away of cut dough pieces at the center of the roller is different than at the ends of the roller. This can cause problems with the output of the cut dough pieces. The stripper wire can be tensioned tightly against the outer surface of the rear roller so to pull it into a straighter configuration. However, the higher the tension in the stripper wire, the faster it will suffer failure from wear.

An aspect of at least one of the inventions disclosed herein includes the realization that adding a center support to a stripper wire assembly of a dough sheeter can provide the dual benefits of normalizing the point of contact between the stripper wire and the outer surface of the front roller and allow the stripper wire to be used on a much wider dough sheeter. For example, a stripper wire assembly can have a stripper wire mount disposed at each end of a front roller, as well as a stripper wire support member disposed at a location between the two ends of the front roller. As such, the central stripper wire mount can reduce the extent to which the stripper wire is pulled upwardly along the outer surface of the front roller and thus have a more uniform point of contact along the front roller. Further, secured as such, the same type of stripper wire assembly can be used on a wider sheeter. This can provide a more efficient design, significantly wider than known dough sheeters, for example, about twice as wide as known dough sheeters.

Thus, using known dough sheeters to provide the output of a dough sheeter in accordance with the present embodiments would require two or more dough sheeters. As such, there would be two drive systems, two front rollers, two rear rollers, two cutting rollers, twice as many bearings, two conveyor belt systems, etc. However, using the improved stripper wire assembly disclosed herein, a dough sheeter can be made much wider using only a single front, rear, and cutter roller as well as a single drive system, a single conveyor belt system, etc. Although these components would be larger, they would not be twice as expensive overall and result in fewer parts.

Another aspect of at least one of the inventions disclosed herein includes the realization that installation or replacement of broken stripper wires can be accelerated by forming the stripper wires with preformed, enlarged ends. For example, a stripper wire can include a preformed loop at one end with an enlarged object captured therein, such as a ring or small piece of rod. As such, a stripper wire can be more quickly replaced on a sheeter machine.

Another aspect of at least one of the inventions disclosed herein includes the realization that a sheeter machine can include a plurality of tension-controlled wire payout mechanisms mounted for paying out stripper wire across subportions of an output roller of a dough sheeting machine. For example, a sheeter can include one or more tension-controlled payout mechanisms mounted adjacent center support of the sheeter machine, each payout mechanism feeding stripper wire through a center support, then across a portion of an output roller. The sheeter machine can also include winding mechanisms, configured to pull the stripper wire from the payout mechanism, through the center support, and across a portion of the output roller in a continuous manner. As such, a sheeter machine can be operated in a more continuous manner with a reduced likelihood of breakage of stripper wire. With this type of system, the stripper wires usually do not break. Rather, the reels on the tension-controlled payout mechanism are emptied over time, in a predictable manner. Thus, replacement of stripper wire spools on the tension-controlled payout mechanisms can be predictably scheduled, thereby enabling the reduction of waste that can result from sudden an unexpected stripper wire failures.

### BRIEF DESCRIPTION OF THE DRAWINGS

The above-mentioned and other features of the inventions disclosed herein are described below with reference to the following drawings. The illustrated embodiments of the sheeter are intended to illustrate, but not to limit, the inventions.

FIG. 1 is a top, front, and right-side perspective view prior art dough sheeter;

FIG. 2 is a left-side elevational view of the dough sheeter of FIG. 1;

FIG. 3 is a cutting roller that can be incorporated into the dough sheeter of FIG. 1;

FIG. 4 is a schematic representation of a front, rear, and cutter roller within the sheeter of FIG. 1;

FIG. 5 is a schematic side elevational view of the roller arrangement of FIG. 4 illustrating a difference in stripping height caused by the use of the stripper wire illustrated in FIG. 4;

FIG. 6 is a front, top, and left-side perspective view of a roller drive and stripper wire assembly in accordance with an embodiment, which can be supported on a support frame such as that illustrated in FIG. 1;

FIG. 7 is an enlarged view of a central stripper wire support of the assembly of FIG. 6;

FIG. 8 is a schematic view of one end of a stripper wire including an enlarged end with a ring captured therein;

FIG. 9 is an enlarged perspective view of the roller drive of FIG. 6, illustrating two stripper wires in the form illustrated in FIG. 8 attached to the center support;

FIG. 10 illustrates a modification of the center support illustrated in FIG. 9;

FIG. 11 is a front, top, and left side perspective view of a modification of the roller drive and stripper wire assembly illustrated in FIG. 6, including two tension-controlled payout mechanisms feeding stripper wire through the center support two tension-controlled winding mechanisms;

FIG. 12 is an enlarged view of the center support of FIG. 11.

### DETAILED DESCRIPTION OF THE PREFERRED EMBODIMENT

The inventions disclosed herein have applicability to sheeters used in conjunction with continuously moving conveyor systems. However, an understanding of the inventions disclosed herein is facilitated with the following description of the application of the principles of the present inventions to dough rolling, and in particular, rolling dough into tortillas and tortilla chips. In some embodiments, the inventions disclosed herein can be used in conjunction with sheeters that have a sheet thickness control system, such as those disclosed in U.S. Pat. Nos. 5,470,599, and 8,740,602, the entire contests of both of which are hereby incorporated by reference.

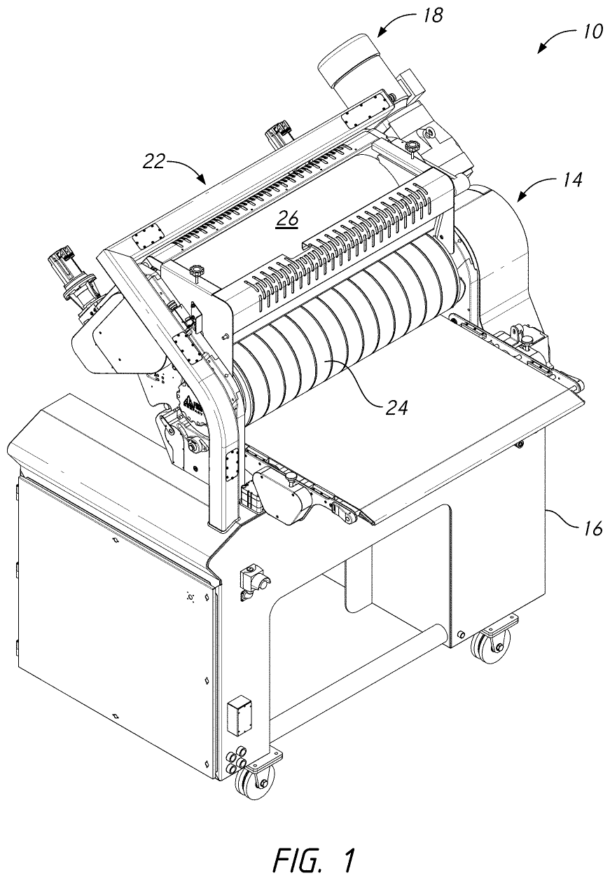

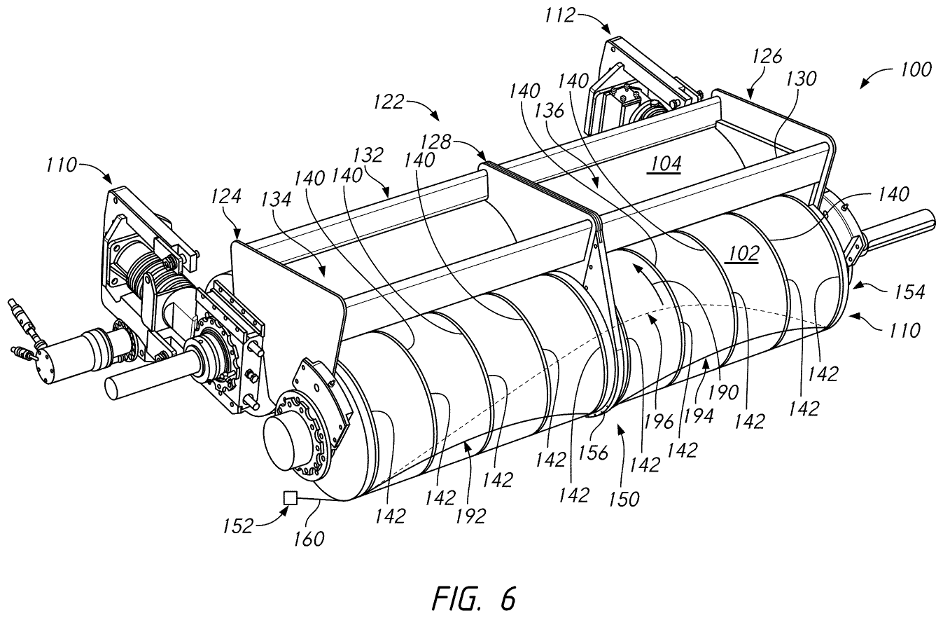

FIG. 1 illustrates a tortilla sheeter 10. The tortilla sheeter 10 is a prior art known tortilla sheeter, in the configuration for tortilla chip production, and can include various types of electronic thickness control, pinch point gap control, and other related systems and functionality. The inventions disclosed herein have applicability to a variety of different types of food rolling machines and sheeters, however, tortilla sheeters, such as the sheeter 10 and the improved sheeter described with reference to FIGS. 6 and 7 are in the form of tortilla sheeters, the basic understanding of which provides useful context for appreciation of the inventions disclosed herein.

With continued reference to FIG. 1, the prior art sheeter 10 includes a roller assembly 14 and a support frame assembly 16. The support frame assembly 16 is in the form of a housing which can include and support various types of devices for operations of the sheeter 10. The roller drive assembly can include an electric motor 18 and an appropriate gear reduction mechanism for driving a shaft of one or both of the rollers. The roller assembly 14 is attached to the support assembly 16. Additionally, a hopper assembly 22 is supported above the rollers of the roller assembly 14.

The roller drive assembly 14 also includes a generally cylindrical front roller 24 and a generally cylindrical rear roller 26. The rollers 24, 26 can have a slightly roughened surface (obtained, for example, with sandblasting). The rollers 24, 26 are rotated in opposite directions and can be driven at the same speed or slightly different speeds, depending on desired performance characteristics. The rollers 24, 26 are positioned generally parallel to each other.

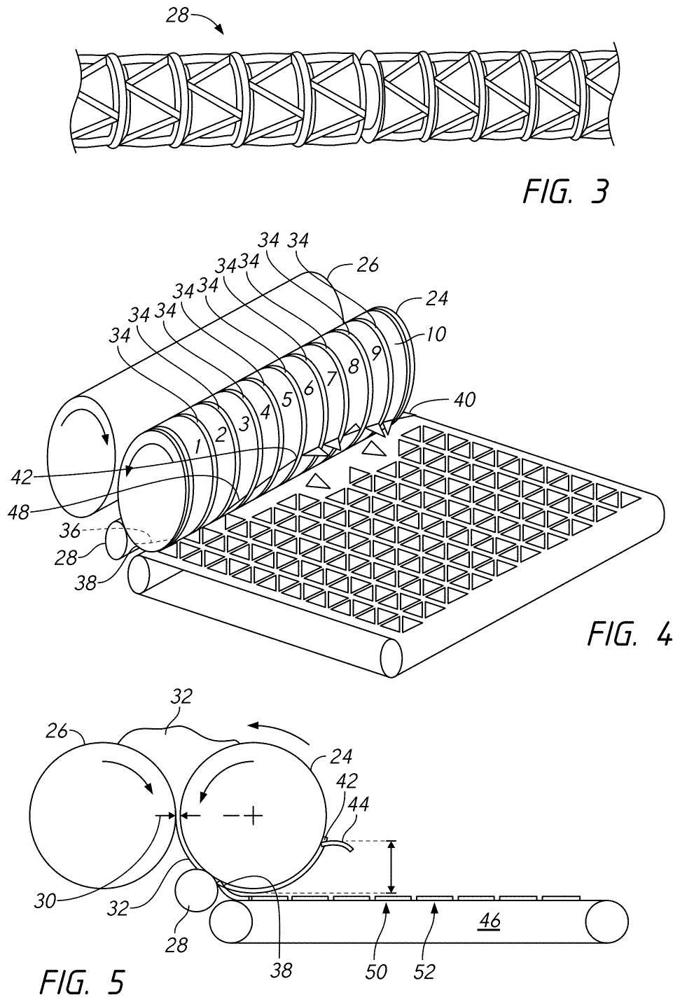

With reference to FIG. 3, the roller assembly 14 can also include a cutting roller 28. The cutting roller 28 is in the form of a cutting roller designed for tortilla chip manufacturing, and thus includes triangular-shaped recesses and edges for cutting triangular pieces of dough. The cutting roller 28 is also mounted within the roller drive 14.

With reference to FIGS. 4 and 5, the rollers 24, 26 are mounted parallel to each other to define a pinch point gap 30. The hopper (FIG. 1) is mounted above the rollers 24, 26 so as to support dough, such as masa 32 above the pinch point gap 30. As such, as the rollers 24, 26 are driven in counter-rotating directions, the masa 32 is pulled into the pinch point gap 30. A thin layer of dough 32 is discharged from the pinch point gap and adhered to an outer surface of the roller 24. As the sheet of dough 32 moves counter-clockwise along with the roller 24 (as viewed in FIG. 5), it is passed between the cutting roller 28 and the outer surface of the front roller 24. The cutting roller 28 cuts the dough sheet 32 into desired shapes. In the illustrated prior art device, the dough is cut into triangular shaped pieces of dough for making tortilla chips.

The front roller 24 also includes a plurality of grooves, in which bands 34 are disposed. The grooves have an inner surface that has a smaller diameter than the inner surface of the bands 34. The bands are sufficiently large that they can be pulled approximately parallel or slightly projecting from the outer surface of the roller 24.

A stripper wire 36 is secured to the roller assembly 14 at locations adjacent to both ends of the front roller 24 and downstream from the cutter roller 28. More specifically, the stripper wire 36 is mounted at the right end of the front roller 24 adjacent to the right-most point of contact 38 and secured at the left end of the roller 24 adjacent to the left-most point of contact 40. The stripper wire is threaded under the bands 34. As such, the stripper wire can strip off cut pieces of dough from the outer surface of the front roller 24 yet allow remaining pieces of dough, referred to as “rework”, to remain in contact with the bands 34 and be fed back into the hopper so as to become reworked with the dough 32 above the pinch point gap (FIG. 5).

With reference to FIG. 4, during operation, the rotation of the roller 24 (counter-clockwise in FIGS. 4 and 5) and the resulting friction between the stripper wire 36 and the outer surface of the roller 24 and the bands 34 (which rotate with the roller 24) causes the stripper wire 36 to be pulled in the counterclockwise direction. As such, the stripper wire tends to follow an arched shape around the front roller 24. For example, as shown in FIG. 4, the right-most point of contact 38 of the stripper wire 36 and the outer surface of the front roller 24 is close to the cutter roller 28. However, towards the center of the front roller 24, the stripper wire 36 is pulled up to an apex 42 which is at the highest point of contact 42 between the stripper wire 36 and the outer surface of the roller 24.

Thus, with continued reference to FIGS. 4 and 5, the difference in height between the right-most contact point 38 and the apex 42 causes individually cut pieces of dough 44 to be separated and fall away from the outer surface of the front roller 24 at different heights. For example, triangular pieces of dough discharge from the front roller 24 near the contact point 36 are dropped immediately down onto an output conveyor assembly 46. At an intermediate contact point 48 between the contact points 36 and 42, the cut pieces of dough fall a distance 50 from the outer surface of the roller to the output conveyor 46. Further, at or near the contact point 42, the cut pieces of dough fall a greater distance 52 which is much greater than the distance 50, onto the output conveyor 46. The higher the contact point 42, the larger the distance 52.

When the distance 52 becomes too large, the cut pieces of dough can flip over, fold on top of themselves, or result in other configurations or orientations that are detrimental to the cooking procedure to follow. Although increasing the tension in the stripper wire 36 can reduce the height of the point of contact 42, the higher the tension in the stripper wire 36, the shorter the lifespan of its use. When a stripper wire breaks, the sheeter must be shut down and a new stripper wire installed. If the rollers 24, 26 were longer, requiring a longer stripper wire, then the central point of contact 42 would be even higher. Thus, the behavior and lifespan of the stripper wire 36 presents a limiting factor in the overall width of a sheeter 10.

An aspect of at least one of the inventions disclosed herein includes the realization that improving the stripper wire mount for a sheeter can accommodate longer rollers that can output a significantly higher amount of cut dough using the same roller speeds.

FIG. 6 illustrates an embodiment of some of the inventions disclosed herein. As shown in FIGS. 6 and 7, an improved roller drive assembly 100 can include an enhanced stripper wire assembly 110, described in greater detail below.

The drive 100 can include a front roller 102 and a rear roller 104 mounted adjacent and parallel to the front roller 102 and so as to define a pinch point gap therebetween (not shown). The roller drive 100 can include pinch point adjustment devices 110, 112 mounted at opposite ends of the rear roller 104. Other configurations can also be used.

The drive 100 also includes a hopper assembly 122. The hopper assembly 122 includes a right sidewall 124, a left sidewall 126 and a center dividing wall 128, which can be referred to as a “saddle”. The hopper 122 also includes a front wall assembly 130 and a rear wall assembly 132. The central wall 130 divides the hopper assembly into a right side hopper portion 134 and a left side portion 136. Thus, when dough, such as masa, is dropped into the hopper 122, it is divided into the right and left hopper portions 134, 136 by the center dividing wall 128.

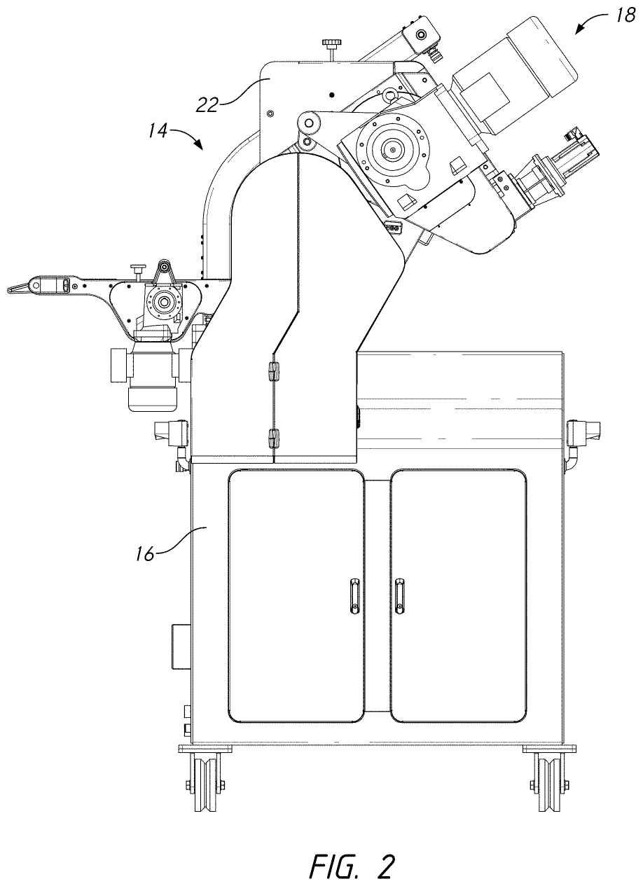

In the illustrated embodiment, the roller drive 100 is configured for tortilla production, for example, round tortillas. Thus, the front roller 102 includes band grooves 140 and band 142 disposed within the grooves 140 and at the outer ends of the working surface of the front roller 102. The distance between the grooves 140 is sized to accommodate the desired diameter of a tortilla cut by the cutting roller (not shown). In this configuration, the front roller 102 is approximately twice as long as the front roller 24 of FIGS. 1-5.

The drive 100 also includes a stripper wire assembly 150. The stripper wire assembly 150 includes a right side mount 152, a left side mount 154 (not shown) and a central mount member 156. The central mount member 156 is aligned with the center divider 128 of the hopper assembly 122. Thus, during operation the center divider 128 prevents dough from the hopper assembly 122 from being fed into the area of the center mount 156.

The stripper wire assembly 150 also includes a stripper wire 160 extending from the right side mount 152 and the above side mount 158 and can be engaged with the central mount 156. In the context of a dough sheeter, the stripper wire 160 can be a thin wire, for example, but without limitation, 16 gauge, 18 gauge, 20 gauge, 22 gauge, or other thicknesses.

With reference to FIG. 7, the central mount 156 can include a mounting portion 170 that extends adjacent to an outer surface of the front roller 102. The projecting portion 170 can include a plurality of mounting locations. In the illustrated embodiment, the projecting portion includes four mounting locations 172, 174, 176, 178. Each of the mounting locations 172, 178 have essentially the same configuration and thus the mounting location 178 is described and applies to all of the mounting locations 172-178.

With continued reference to FIG. 7, the mounting location 180 includes an opening slot 180 and an enlarged passage 182 at an inner end of the opening slot 178. The width of the opening slot 180 can be approximately the same diameter as the stripping wire 160, optionally, with a small additional clearance to facilitate insertion of the stripping wire 160 into the internal large portion 182.

The large portion 182 can be a channel or cylindrical bore having an inner dimension larger than the width of the slot 180. As such, when the stripper wire 160 is inserted through the opening 180 into the enlarged portion 182, the enlarged portion 182 can better capture the stripper wire 160 and secure it within the enlarged portion 182 whether the roller 102 is moving or stationary.

With reference to FIGS. 6 and 7, the stripper wire 160 can be secured to any one of the mounting portions 172-178. FIGS. 6 and 7 illustrate the stripper wire 160 attached to the mounting location 172.

During operation, when the front roller 102 is driven in the direction of the arrow 190, the stripper wire 160 is pulled upwardly. Thus, with the stripper wire 160 positioned within the enlarged portion of the mounting location 172, the stripper wire falls along a double-humped configuration having a first apex 192 on a right side portion of the front roller 102 and a left-side apex 194 on the left-side portion of the front roller 102. The maximum height of the apexes 192, 194 is significantly lower than what might result during operation of the roller assembly 100 without central mounting portion 156.

For example, the stripper wire 160 might tend to rise to a much higher apex 196 illustrated in phantom line in FIG. 6. To prevent the stripper wire from being pulled to such a high apex, tension on the stripper wire 160 could be increased with the stripper wire mounts 152, 154. However, as noted above, increased tension in the stripper wire shortens the lifespan of the stripper wire 160 and thus would result in more down time of the sheeter 100. Thus, the stripper wire assembly 150 of the present embodiment can provide the dual benefits of providing a more uniform point of contact between the stripper wire 160 and the outer surface of the front roller 102 with a lower required tension in the stripper wire 160. As such, the roller drive 100 can be much wider than those of the prior art. In the illustrated example, the roller drive 100 can be significantly longer then some known rollers, thereby providing greater output in terms of tortillas per hour than possible with prior art sheeters such as the sheeter in FIGS. 1-5. Further, the improved stripper wire assembly 150 can be used on existing older sheeters, such as the sheeter 10 illustrated in FIGS. 1-5, to provide a more uniform line of contact with the front roller and lower tensions, thereby increasing the lifespan of the stripper wire and reducing down time of the associated sheeter.

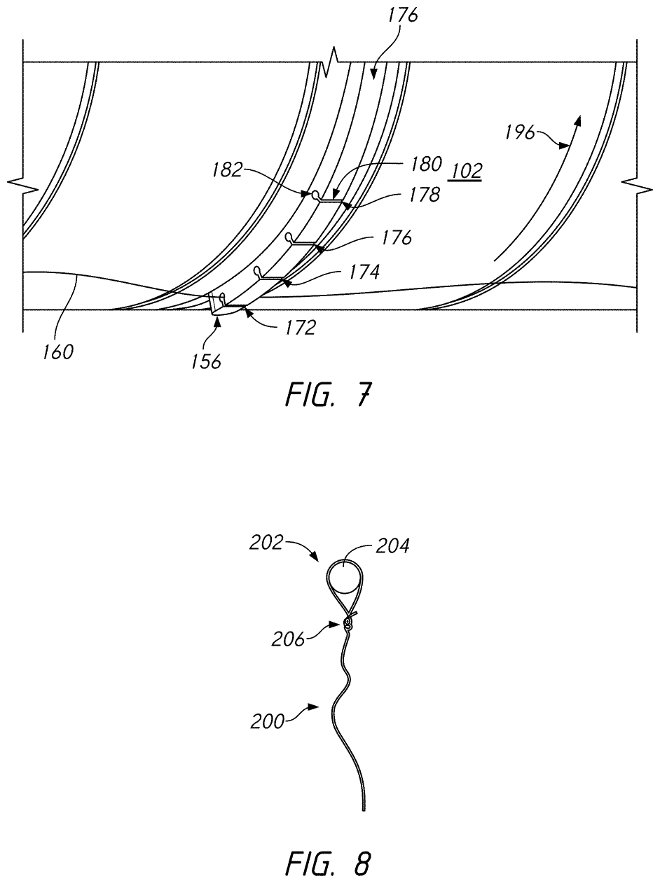

FIGS. 8-10 illustrate another modification of the stripper wire assembly 110 which incorporates the use of preformed stripper wire segments having an enlarged end designed for improved or enhanced installation efficiency.

FIG. 8 illustrates an improved preformed stripper wire 200 having a preformed enlarged head 202 at one end thereof. The enlarged head 202 can have any configuration. In the illustrated embodiment, the enlarged head 202 comprises a ring 204 with a groove on its outer periphery. The ring can be made of any material. In some embodiments, the material is a material compatible and appropriate for food production machinery. For example, the ring 204 can be stainless steel, brass, plastic or other materials. Additionally, other shapes can also be used.

The enlarged head 202 is formed of a length of the stripper wire 200 extending around the ring 204 into the groove in the outer surface thereof, then wound around itself forming a tightly wound portion 206 that is sufficiently tight for capturing the ring 204 in the enlarged head 202 of the stripper wire 200. This type of configuration for preformed thin wire is common in the guitar string industry.

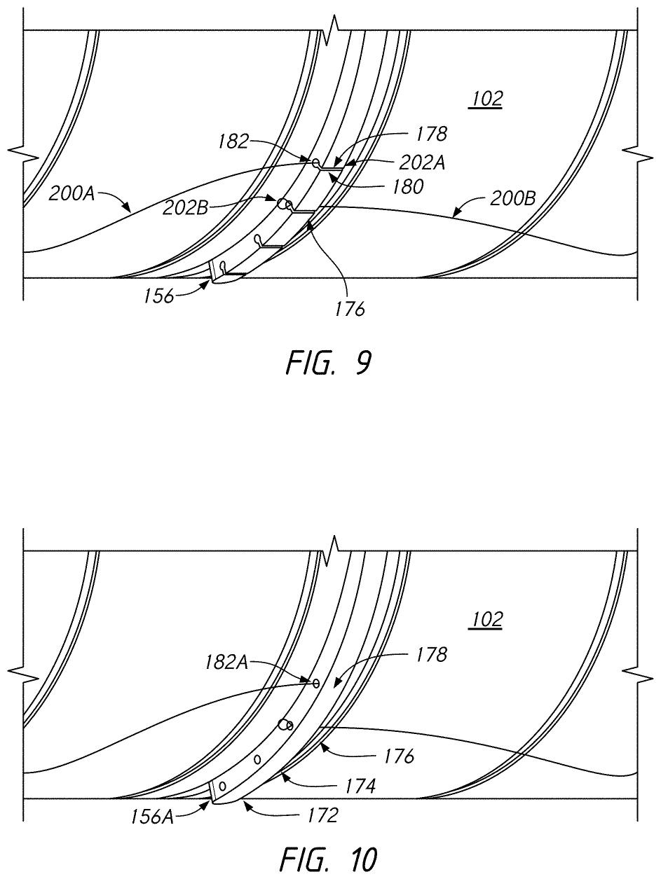

FIG. 9 illustrates attachment of the preformed stripper wire 200 with the central mount member 156. As shown in FIG. 9, a first one of the improved stripper wire 200, identified as 200A in FIG. 9, is inserted through the opening slot 180 of the mounting location 178 with the enlarged head 202A on the right side of the support 156 (as viewed in FIG. 9), the enlarged head 202A being larger than the central passage 182. Similarly, a second improved stripper wire 200B can be supported within the mounting location 176 in a similar manner, with the enlarged head 202B disposed on the left side of the mounting location 176 (as viewed in FIG. 9).

In this configuration, the stripper wires 200A, 200B are captured within the mounting locations 178 and 176 because the diameter of the wires used to form the stripper wires 200A, 200B is smaller than the opening slot 180 and enlarged passages 182. However, the enlarged heads 202A, 202B are significantly larger than the enlarged passage 182. Thus, the enlarged heads cannot pass through the enlarged passage 182 and are thereby captured and held securely in place during operation. The free ends (not shown) of the stripper wires 200A, 200B can be secured to mounting locations 152, 154 as described above with reference to FIG. 6. Other configurations can also be used.

FIG. 10 illustrates a modification of the central support 156, identified generally by the reference numeral 156A. In this modification of the central mount member 156A, the mounting locations 172, 174, 176, 178 are formed as through-holes through the central mount 156A, without corresponding opening slots, such as the opening slots 180 (FIG. 9). Rather, the through-holes form the enlarged passages 182A in each of the mounting locations 172-178. As such, when used in conjunction with the improved preformed stripper wire 200, the stripper wire can be easily threaded through the passages 182A of any of the selected mounting locations 172-178 and secured in place during an installation procedure. Further, the elimination of the opening slot 180 can help prevent the stripper wire 200 from accidentally slipping out of the passage 182A during an installation procedure. Optionally, both stripper wires 200A, 200B can be secured to the same mounting location 172, 174, 176, or 178, and extend in opposite directions, thereby preserving a balanced alignment of the stripper wires 200A, 200B across the roller 102.

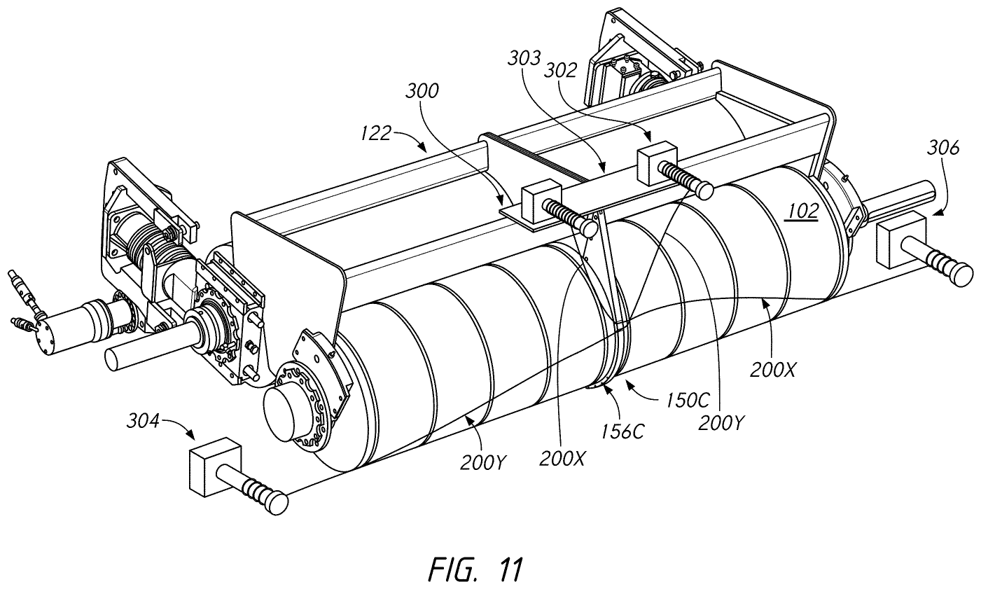

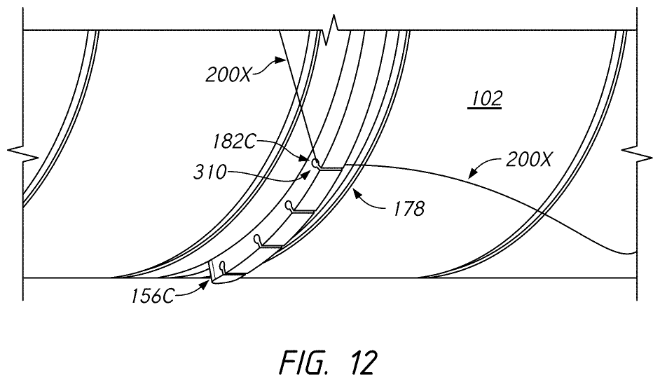

FIGS. 11-12 illustrate another modification of the stripper wire support assembly 150 identified generally by the reference numeral 150C. Parts, components, and advantages disclosed above with reference to the support assembly 150 which correspond to the same or similar parts, components and advantages of support assembly 150C are identified with the same reference numeral except the letter “C” has been added thereto.

With reference to FIG. 11, the stripper wire support assembly 150C is configured to feed stripper wire through the support during operation. In the illustrated arrangement, the support assembly 150C includes a first wire payout mechanism 300 and a second wire payout mechanism 302. The payout devices 300, 302 are supported by support plate 303 mounted to the hopper 122.

The first and second wire payout mechanisms 300, 302 can be in the form of spools of stripper wire connected to constant tension feed mechanisms. Many different kinds of constant tension wire feed systems can be used. For example, some commercially available systems are known as “constant tension payoff systems” that are configured to provide constant tension, regardless of spool diameter or wire speed. For example, such systems are commercially available from Magnetic Brake Systems, Inc., and other sources.

Generally, these types of systems include a controller, which can be in the form of a motor or brake system that controls the payout of a material such as a wire from a spool. Typically, these types of systems are adjustable and include a user input for adjusting the tension maintained in the spool during payout of material from the attached spool. Further, these types of devices can be configured to accommodate variable speed of payout while providing a constant tension.

The stripper wire arrangement 150C can also include stripper wire takeup devices 304, 306. The takeup mechanisms 304, 306 can each include a spool and a motor configured to rotate the spool so as to pull stripper wire 200Y, 200X from the corresponding payout mechanism 302, 300. In some embodiments, the takeup devices 304, 306 are configured to operate at constant speed. Such a configuration has long been known in many fields and can be provided by a simple controller (not shown) and an electric motor (not shown) configured to drive the electric motor at a constant speed.

As such, the controller modulates the total power, and in some devices, modulates the current at a constant voltage, to drive the motor at a constant velocity, modulating the power delivered to the motor to overcome variations in load. In this context, under normal operation, the payout devices 302, 300 would provide a constant or substantially constant tension in the stripper wires 200Y, 200X, which could be measured in the stripper wires near the spool payout devices 302, 300.

The stripper wires 200Y, 200X can be threaded through the center support 156C and to a corresponding takeup mechanism 304, 306. By way of contact with the center support 156C and the outer surface of the roller 102, additional friction and load might be imparted in the form of additional tension generated in the stripper wires 200Y, 200X at the takeup mechanisms 304, 306. Thus, conventional constant speed motors and controllers at the takeup devices 304, 306 can automatically apply additional power to overcome the additional tension thereby created.

With reference to FIG. 12, the central support 156C can be in the form of any of the previously disclosed supports 156, 156A. Additionally, with reference to FIG. 12, the central passages 182C of the support 156C can include a tapered opening 310 shaped for the purpose of providing a smoother transition from the outer side surfaces of the support 156C to the central passage 182C and thereby prevent the stripper wire from being rubbed against sharp edges. This can provide additional protection against inadvertent breaking of the associated stripper wire.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A dough sheeting device comprising:
a support housing;
a rear roller having a first outer surface and supported by the support housing to rotate about a first axis;
a front roller having a second outer surface and supported by the support housing to rotate about a second axis spaced from the first axis such that juxtaposed portions of the first and second outer surfaces define a pinch point gap, the front roller comprising a plurality of grooves recessed from the second outer surface and a plurality of bands disposed within the plurality of grooves, respectively, the second outer surface being divided into a left side portion and a right side portion and a gap disposed between the left side portion on the right side portion;
a hopper assembly comprising a front wall, a rear wall, a right side wall, a left side wall, and a center wall defining a hopper trough, the center wall dividing the hopper trough into a left side hopper trough and a right side hopper trough, the center wall aligned with the gap in the second outer surface;
a stripper wire assembly, comprising:
a first stripper wire amount disposed adjacent a first end of the front roller;
a second stripper wire mounts disposed at a second end of the front roller;
a third stripper wire mounts disposed between the first and second stripper wire mounts;
a stripper wire connected to the first, second, and third stripper wire mounts and beneath the band, the stripper wire mounted with sufficient tension to maintain the stripper wire in contact with the second outer surface of the front roller.

2. The dough sheeting device according to claim 1, wherein the third stripper wire mount comprises a plurality of stripper wire mounting locations.

3. The dough sheeting device according to claim 2, wherein the plurality of stripper wire mounting locations comprise slots.

4. The dough sheeting device according to claim 2, wherein the plurality of stripper wire mounting locations are configured to engaged and disengage with a stripper wire without tools.

5. The dough sheeting device according to claim 1, wherein the third stripper wire mount is aligned with the center wall of the hopper assembly.

6. The dough sheeting device according to claim 3, wherein the center wall blocks dough from being carried onto the third stripper mount.

7. A dough sheeting device comprising:
a support housing;
a rear roller having a first outer surface and supported by the support housing to rotate about a first axis;
a front roller having a second outer surface and supported by the support housing to rotate about a second axis spaced from the first axis such that juxtaposed portions of the first and second outer surfaces define a pinch point gap;
a hopper assembly;
a stripper wire assembly, comprising:
a first stripper wire amount disposed adjacent a first end of the front roller;
a second stripper wire mounts disposed at a second end of the front roller;
a third stripper wire mounts disposed between the first and second stripper wire mounts;
a stripper wire connected to the first, second, and third stripper wire mounts.

8. The dough sheeting device according to claim 7 wherein the front roller comprises a plurality of grooves recessed from the second outer surface and a plurality of bands disposed within the plurality of grooves, respectively, the second outer surface being divided into a left side portion and a right side portion and a gap disposed between the left side portion on the right side portion.

9. The dough sheeting device according to claim 8, wherein the stripper wire extends beneath the bands, the stripper wire mounted with sufficient tension to maintain the stripper wire in contact with the second outer surface of the front roller.

10. The dough sheeting device according to claim 7, wherein the hopper assembly comprises a front wall, a rear wall, a right side wall, a left side wall, and a center wall defining a hopper trough, the center wall dividing the hopper trough into a left side hopper trough and a right side hopper trough.

11. The dough sheeting device according to claim 7, wherein the third stripper wire mount comprises a plurality of stripper wire mounting locations.

12. The dough sheeting device according to claim 11, wherein the plurality of stripper wire mounting locations comprise slots.

13. The dough sheeting device according to claim 11, wherein the plurality of stripper wire mounting locations are configured to engaged and disengage with a stripper wire without tools.

14. The dough sheeting device according to claim 7, wherein the third stripper wire mount is aligned with a center wall of the hopper assembly.

15. The dough sheeting device according to claim 14, wherein the center wall blocks dough from being carried onto the third stripper mount.

16. A dough sheeting device comprising:
a support housing;
a rear roller having a first outer surface and supported by the support housing to rotate about a first axis;
a front roller having a second outer surface and supported by the support housing to rotate about a second axis spaced from the first axis such that juxtaposed portions of the first and second outer surfaces define a pinch point gap;
a hopper assembly;
a stripper wire assembly, comprising:
a first stripper wire amount disposed adjacent a first end of the front roller;
a second stripper wire mounts disposed at a second end of the front roller;
a stripper wire mounting means for tool-less, adjustable connection to a stripper wire, disposed between the first and second stripper wire mounts;
a stripper wire connected to the first and second stripper wire mounts and the stripper wire mounting means.

17. The dough sheeting device according to claim 7 wherein the front roller comprises a plurality of grooves recessed from the second outer surface and a plurality of bands disposed within the plurality of grooves, respectively, the second outer surface being divided into a left side portion and a right side portion and a gap disposed between the left side portion on the right side portion.

18. The dough sheeting device according to claim 16, wherein the stripper wire mounting means comprises a plurality of stripper wire mounting locations.

19. The dough sheeting device according to claim 16, wherein the stripper wire mounting means comprises a plurality of open grooves arrange parallel to each other.

20. The dough sheeting device according to claim 19, wherein the stripper wire mounting means comprises a plurality of enlarged recesses opening into grooves on the second outer surface of the front roller.
